(19) United States
(12) Patent Application Publication
(10) Pub. No.: US 2006/0172756 A1
(43) Pub. Date: Aug. 3, 2006

(54) System and method for clustering mobile devices in a wireless network

(76) Inventor: Jacob Sharony, Dix Hills, NY (US)

Correspondence Address: FAY KAPLUN & MARCIN, LLP, 15O BROADWAY, SUITE 702, NEW YORK, NY, 10038, US

(21) Appl. No.: 11/047,056

(22) Filed: Jan. 31, 2005

(51) Int. Cl. H04Q 7/20

(52) U.S. Cl. 455/519; 455/518

(57) ABSTRACT

Described are a system and method for clustering mobile devices in a wireless network. The system includes a wireless access point (“AP”) and a plurality of mobile units (“MUs”). Each of the MUs has a wireless transducer. At least two MUs of the MUs are grouped, based on a predetermined parameter, into a cluster which included a head MU and at least one member MU. Communications between the at least one member MU and the AP are conducted via the head MU.

### BACKGROUND INFORMATION

Known wireless network systems (e.g., 802.11 wireless networks) generally operate in two distinct modes: infrastructure and ad hoc (e.g, peer-to-peer). In the infrastructure mode, mobile units may communicate with other mobile units within the wireless network via an access point (“AP”). In the ad hoc mode, mobile units may communicate with one another directly.

The known wireless network systems have several shortcomings. For example, each mobile unit often transmits at the same high power level regardless of its proximity to the AP and therefore-wastes power and causing interference. In addition, cooperation between mobile units residing in the same wireless network is often limited. Therefore, there is a need for an improved wireless network architecture.

### SUMMARY OF THE INVENTION

The present invention relates to a system and method for clustering mobile devices in a wireless network. The system includes a wireless access point (“AP”) and a plurality of mobile units (“MUs”). Each of the MUs has a wireless transducer. At least two MUs of the MUs are grouped, based on a predetermined parameter, into a cluster which included a head MU and at least one member MU. Communications between the at least one member MU and the AP are conducted via the head MU.

### BRIEF DESCRIPTION OF DRAWINGS

FIG. 1 shows an exemplary embodiment of a system according to the present invention; and

FIG. 2 shows an exemplary embodiment of a method according to the present invention.

### DETAILED DESCRIPTION

Disclosed is a system and method for clustering mobile devices in a wireless network. In particular, the present invention relates to an improved wireless network architecture that, for example, uses location information of mobile units to form clusters of mobile units.

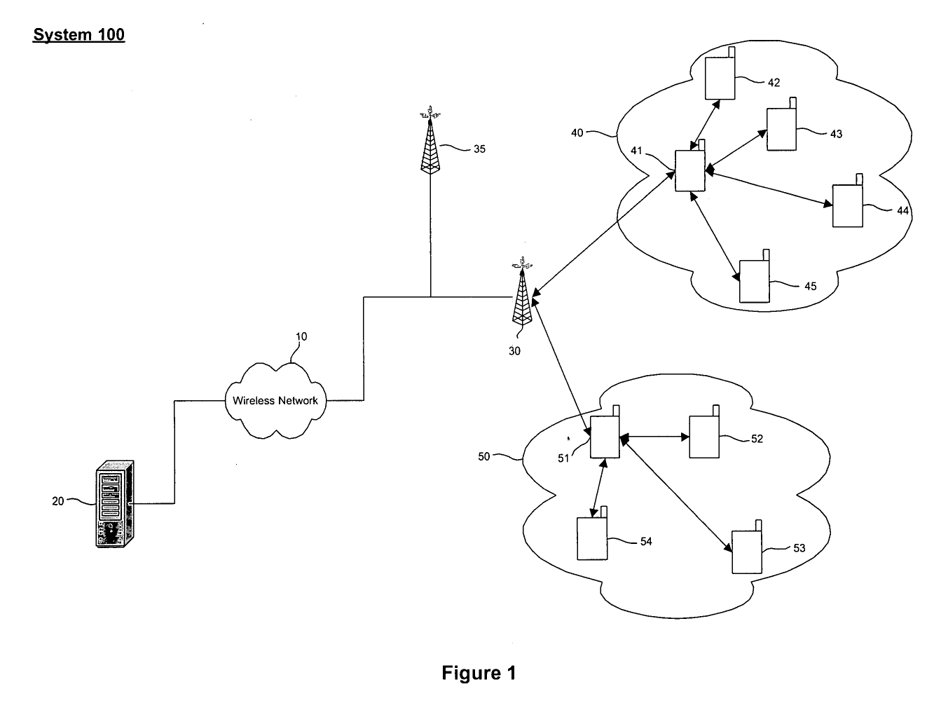

FIG. 1 shows an exemplary embodiment of a system 100 according to the present invention. The system 100 may include a wireless communications network 10 (e.g., a Wireless Local Area Network (“WLAN”)). The wireless network 10 may be, for example, a wireless network as described by IEEE 802.11 specifications. The wireless network 10 may include at least one access point (“AP”), such as an AP 30 and/or an AP 35. The system 100 also includes a server 20 in communication with the wireless network 10.

The system 100 may include a number of mobile units (“MUs”), e.g., MUs 41-45 and 51-54. The MU may be any mobile unit and/or networking device (e.g., a network node) known to those of ordinary skill in the art which includes a wireless transducer. For example, the MU may be a portable barcode scanner, a mobile phone, a two-way pager, PDA, etc. Each MU may communicate with the wireless network 10 via an AP (e.g., AP 30) of the wireless network 10. As described below, each MU may also communicate with the wireless network 10 via another MU.

Two or more MUs may be grouped into a cluster based on a plurality of factors such as geographical proximity to one another, an internal load level, a battery level, a hardware configuration, etc. For example, the MUs 41-45 may be grouped into a cluster 40 and the MUs 51-54 may be grouped into a cluster 50. In preferred embodiment of the present invention, each cluster includes one cluster-head MU and at least one cluster-member MU. For example, the cluster 40 may includes the cluster-head MU 41 and the cluster-member MUs 41-45. Similarly, the MU 51 may be the cluster-head of the cluster 50 and the MUs 51-54 are the cluster-member MUs. In each cluster, a cluster-member MU communicates with the cluster head MU using, e.g., IEEE 802.11 technology; the cluster-head MU communicates with the AP using, e.g., IEEE 802.11 and/or 802.16 (WiMAX) technology. In an alternative exemplary embodiment of the present invention, the cluster may include two or more cluster-head MUs; or the cluster may further be subdivided into a plurality of sub-clusters, each sub-cluster having a structure similar one of the cluster.

As one of ordinary skill in the art will understand, the cluster may be dynamically changing its membership. For example, the membership of a particular cluster may continuously change depending on the relative locations of its MUs. As shown in FIG. 1, the MU 45 is the cluster-member of the cluster 40. However, if the MU 45 change its location (e.g., in a direction towards the MUs 51-54), then the MU 45 may become a cluster-member of the cluster 50. Furthermore, a particular MU may be a cluster-head MU at one time and a cluster-member MU at another time (e.g., depending on the relative locations of the MUs, internal load, battery level, etc). One or more MUs (e.g., at a particular time/location) may also not be associated with any cluster and may communicate directly with the AP 30.

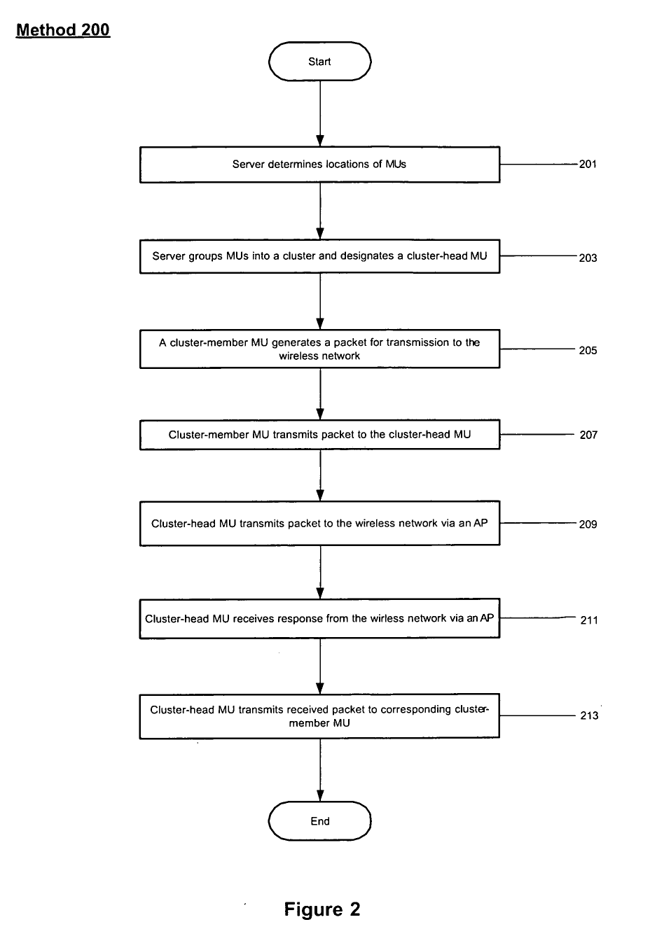

FIG. 2 shows an exemplary method 200 of communication according to the present invention. The method 200 is described with reference to the system 100 in FIG. 1. Those skilled in the art will understand that other systems having varying configurations, for example, different numbers of WLANs, AP's, and MU's may also be used to implement the exemplary method.

In step 201, the system 100 may determine locations and/or relative locations of the MU's in communication with the wireless network 10. The system 100 may use any real time location system or any other methods known to those of ordinary skill in the art. For example, the system 100 may employ a Received Signal Strength Indication (“RSSI”) method. The server 20 may generate and transmit a signal via one or more APs (e.g., APs 30 and/or 35). Each MU may then transmit a response signal to the APs 30 and/or 35. The APs 30/35 may receive the response signal and forward it to the server 20. The server 20 may then utilize the intensity of the response signal(s) and compare it with predetermined geographically marked locations or points (e.g., within the wireless network 10 coverage area) to determine the relative locations of the MUs (e.g., the MUs 41-45 and 51-54).

The system 100 may, alternatively, or in combination, employ a Time Difference Of Arrival (“TDOA”) method to determine the relative locations of the MUs (step 201). For example, the server 20 may generate and transmit a signal to the MUs via at least one of the APs 30 and/or 35. The MUs may each transmit a response signal to the wireless network 10 via at least two APs (e.g., APs 30/35). The APs 30/35 may then forward the response signals to the server 20. The server 20 may utilize the TDOA method using response signals at each AP 30/35 and compare them to determine the precise location of each MU.

In step 203, the server 20 may group the MUs into clusters based on a plurality of factors mentioned above. In a preferred embodiment, the server 20 may cluster MUs based their location (e.g., within the range of the wireless network 10); the server 20 also determines/designates a cluster-head MU. As shown FIG. 1, the server 20 may cluster the MUs 41-45 into the cluster 40 and the MUs 51-54 into the cluster 50. A cluster-head MU may then be determined in each cluster depending on a number of factors which may be similar to the ones used to group the MUs into the clusters, e.g., the location of the MUs, the internal load, hardware configuration and/or the battery level. For example, the MU 41 may be designated as the cluster-head MU 41 of the cluster 40, and the MU 51 may be designated as the cluster-head MU 51 of the cluster 50. The destination of the MU 41 as the cluster head may be based on the location with respect to the cluster-member MUs 42-45 and/or the location with respect to the AP 30; alternately, such a designation may be based on the fact that the MU 41 has certain hardware which is not available in other cluster-member MUs (e.g., a particular type of transducer).

As one of ordinary skill in the art will understand, steps 201 and 203 may be repeated at any time interval or upon request by a user. Therefore, the MUs included in a cluster and/or the cluster-head MU may change over time. For example, in the wireless network 10 where the MUs are continuously changing location, the system 100 may determine the locations of the MU's (step 201) and cluster the MUs (step 203) at a short interval (e.g., every few minutes). In the wireless network 10 where the MUs are fixed in location or have limited mobility, the system 100 may repeat steps 201-203 only upon user request or at a prolonged interval (e.g., every 48 hours).

In step 205, one or more cluster-member MUs generate a packet for transmission. For example, the cluster-member MU 43 generates a packet for transmission to the wireless network 10. The cluster-member MU 43 transmits the packet to the cluster-head MU 41 (step 207); the cluster-head MU 41 may then transmit (e.g., relay) the packets the wireless network 10 via the AP 30 (step 209). Other cluster-member MUs (e.g., MUs 42, 44, 45) may, at the same or different times, also transmit a packet to the cluster-head MU 41 for further transmission. For example, the cluster-head MU 41 may receive multiple packets from the cluster-member MUs and may aggregate the multiple packets to fewer (e.g., one) packets for transmission to the wireless network 10. As one of ordinary skill in the art will understand, such aggregation of packets may result in decreased congestion and/or interference in the wireless network 10 and less overhead.

In step 211, the cluster-head MU 41 may receive a response signal from the wireless network 10 via the AP 30. The cluster-head MU 41 may determine to which one of the cluster-member MUs 42-45 of the cluster 40 the transmission is intended and transmit the response signal (e.g., packet) to the corresponding MU (e.g., the MU 43) (step 213).

The present invention provides several advantages over known communication systems and methods of communication in wireless networks. As described above, data transmission to and from the cluster-member MUs in a cluster may be relayed through a cluster-head MU. Therefore, the cluster-member MUs may operate at a reduced power level.

The system and method of the present invention also allow for multiple simultaneous transmissions via the aggregation of packets from the cluster-member MU's. For example, MU 42 may communicate with the MU 41 and, at the same time—i.e., simultaneously, the MU 53 may communicate with MU 51. Furthermore, the rotation (e.g., steps 201-203) of cluster-head MUs in a cluster may result in increased throughput and longer battery life in the MUs.

Embodiments of the present invention also include the benefit of relaying “unheard” packets from distant MUs, thus resulting in better resource utilization. In other words, a cluster-member MU which otherwise is unable to communicate with the AP (e.g., because of its location outside of the AP's range), may now communicate with the AP via the cluster-head MU.

The present invention has been described with reference to an embodiment having the MUs 41-45 and 51-54, the wireless network 10, and the APs 30 and 35. One skilled in the art would understand that the present invention may also be successfully implemented, for example, for any number of MUs, APs, and/or a plurality of the wireless networks 10. Accordingly, various modifications and changes may be made to the embodiments without departing from the broadest spirit and scope of the present invention as set forth in the claims that follow. The specification and drawings are accordingly to be regarded in an illustrative rather than restrictive sense.

What is claimed is:

1. A system, comprising:
a wireless access point (“AP”); and
a plurality of mobile units (“MUs”), each of the MUs including a wireless transducer,
wherein at least two MUs of the MUs are grouped, based on a predetermined parameter, into a cluster, the cluster including a head MU and at least one member MU, and
wherein communications between the at least one member MU and the AP are conducted via the head MU.

2. The system according to claim 1, wherein the predetermined parameter includes at least one of a location of the MUs, a battery level of the MUs, a hardware configuration of the MUs and an internal load of the MUs.

3. The system according to claim 1, wherein the head MU is selected from the at lest two MUs based on a further predetermined parameter, the further parameter including at least one of a location of the at least two MUs, a battery level of the at least two MUs, a hardware configuration of the at least two MUs and an internal load of the least two MUs.

4. The system according to claim 3, wherein the selection of the head MU is changed upon a predetermined change of the further parameter.

5. The system according to claim 1, wherein the cluster is changed upon a predetermined change of the parameter.

6. The system according to claim 1, wherein the cluster is further subdivided into at least two subclusters, each subcluster including a subcluster head and at least one subcluster member, the subcluster member communicating with the cluster head via the subcluster head.

7. The system according to claim 1, wherein at least two further MUs of the MUs are grouped, based on the predetermined parameter, into a further cluster, the further cluster including a further head MU and at least one further member MU, and wherein communications between the at least one further member MU and the AP are conducted via the further head MU.

8. The system according to claim 7, wherein a first communication between the head MU and the member MU is simultaneously conducted with a second communication between the further head MU and the further member MU.

9. A method, comprising the steps of:
grouping at least two mobile units (“MUs”) of a plurality of MUs into a cluster based on a predetermined parameter, the cluster including a head MU and at least one member MU;
selecting the head MU from the at least two MUs based on a further predetermined parameter; and
conducting wireless communications between the at least one member MU and a wireless access point via the head MU.

10. The method according to claim 9, wherein the predetermined parameter includes at least one of a location of the MUs, a battery level of the MUs, a hardware configuration of the MUs and an internal load of the MUs.

11. The method according to claim 9, wherein the further predetermined parameter includes at least one of a location of the at least two MUs, a battery level of the at least two MUs, a hardware configuration of the at least two MUs and an internal load of the least two MUs.

12. The method according to claim 11, wherein repeating the selecting step when there is a predetermined change of the further parameter.

13. The method according to claim 9, wherein repeating the grouping step when there is a predetermined change of the parameter.

14. The method according to claim 9, further comprising the step of:
subdividing the cluster into at least two subclusters, each subcluster including a subcluster head and at least one subcluster member
wherein the subcluster member communicates with the cluster head via the subcluster head.

15. The method according to claim 9, further comprising the steps of:
grouping at least further MUs of the MUs into a further cluster based on the predetermined parameter, the further cluster including a further head MU and at least one further member MU;
selecting the further head MU from the at least two MUs based on the further parameter; and
communicating between the at least one further member MU and the access point via the further head MU.

16. The method according to claim 15, wherein a first communication between the head MU and the member MU is simultaneously conducted with a second communication between the further head MU and the further member MU.

17. A method, comprising the steps of:
determining a location of each of a plurality of computing device, each of the devices including a wireless transducer;
selecting at least two device of the devices based on the location of the devices;
creating a cluster of the at least two devices, the cluster including a head device and at least one member device;
designating one of the at least two device as the head device,
wherein wireless communications of the at least one member device are conducted via the cluster head.
